(19) United States
(12) Patent Application Publication
(10) Pub. No.: US 2022/0200390 A1
(43) Pub. Date: Jun. 23, 2022

(54) MOTOR, COMPRESSOR, AIR CONDITIONER, AND MANUFACTURING METHOD OF MOTOR

(71) Applicant: Mitsubishi Electric Corporation, TOKYO (JP)

(72) Inventors: Yuji HIROSAWA, Tokyo (JP); Masahiro NIGO, Tokyo (JP)

(21) Appl. No.: 17/606,685

(22) PCT Filed: May 20, 2019
(86) PCT No.: PCT/JP2019/019886

§ 371 Date: Oct. 26, 2021

(51) Int. Cl. H02K 5/04; H02K 15/02; H02K 1/18; F04B 35/04

(52) U.S. Cl. CPC H02K 5/04; F04B 35/04; H02K 1/18; H02K 15/02

(57) ABSTRACT

A motor includes a rotor rotatable about an axis, a stator having a stator core surrounding the rotor from an outer side in a radial direction about the axis, and an annular shell in which the stator core is fixed. The shell includes a first shell portion facing the stator core in the radial direction and having an inner diameter D1, a second shell portion contacting the stator core in the radial direction and having an inner diameter D2, and a third shell portion protruding from the stator core in a direction of the axis and having an inner diameter D3. The inner diameters D1, D2 and D3 satisfy D1>D2 and D1>D3.

### CROSS REFERENCE TO RELATED APPLICATION

This application is a U.S. National Stage Application of International Application No. PCT/JP2019/019886 filed on May 20, 2019, the contents of which are incorporated herein by reference.

### TECHNICAL FIELD

The present invention relates to a motor, a compressor, an air conditioner, and a manufacturing method of the motor.

### BACKGROUND

A stator of a motor includes a stator core formed by stacking steel laminations. The stator core is fixed inside a shell of a compressor or the like by shrink-fitting or press-fitting (for example, Patent Reference 1).

### PATENT REFERENCE

[PATENT REFERENCE 1]

Japanese Patent Application Publication No. 2005-151648 (see FIG. 1)

However, when the stator core is fixed to the shell, the stator core is applied with a compressive stress by the shell. This may change the magnetic properties of the stator core, and may increase the iron loss.

### SUMMARY

The present invention is intended to solve the above-described problem, and an object of the present invention is to firmly fix a stator core to a shell and to reduce the iron loss.

A motor according to an aspect of the present invention includes a rotor rotatable about an axis, a stator having a stator core surrounding the rotor from an outer side in a radial direction about the axis, and an annular shell in which the stator core is fixed. The shell includes a first shell portion facing the stator core in the radial direction and having an inner diameter Dl, a second shell portion contacting the stator core in the radial direction and having an inner diameter D2, and a third shell portion protruding on each of both sides of the stator core in a direction of the axis and having an inner diameter D3. The inner diameters D1, D2 and D3 satisfy D1>D2 and D1>D3.

With the above-described configuration, the stator core can be firmly fixed to the shell by contact between the second shell portion and the stator core. Since the first shell portion does not contact the stator core, an increase in the iron loss in the stator core can be suppressed. Furthermore, the third shell portion can prevent the stator core from being pulled out from the shell. That is, the stator core can be firmly fixed to the shell, and the iron loss can be reduced.

### BRIEF DESCRIPTION OF THE DRAWINGS

FIG. 1 is a cross-sectional view illustrating a motor of a first embodiment.

FIG. 2 is a cross-sectional view illustrating a stator core and a shell of the first embodiment.

FIG. 3 is a perspective view illustrating a part of the stator core of the first embodiment.

FIG. 4 is a perspective view illustrating the part of the stator core of the first embodiment, and illustrating an insulator and an insulating film which are attached to the part of the stator core.

FIG. 5 is a longitudinal-sectional view illustrating the motor of the first embodiment.

FIG. 6 is a longitudinal-sectional view illustrating the stator core and the shell of the first embodiment.

FIG. 7 is a flowchart illustrating a manufacturing process of the motor of the first embodiment.

FIGS. 8(A) and 8(B) are schematic diagrams illustrating an example of a formation method of a first shell portion of the first embodiment.

FIGS. 9(A) and 9(B) are schematic diagrams illustrating a shrink-fitting step of the stator into the shell in the first embodiment.

FIG. 10 is a longitudinal-sectional view illustrating the stator core and the shell after the shrink-fitting step in the first embodiment.

FIG. 11 is a schematic diagram illustrating a method for fixing the stator core and the shell in the first embodiment.

FIG. 12 is a longitudinal-sectional view illustrating a motor of a comparison example.

FIG. 13 is a graph illustrating a relationship between a compressive stress applied to the stator core and a rate of increase in iron loss.

FIG. 14 is a graph illustrating a relationship between a pull-out load and the rate of increase in iron loss.

FIG. 15 is a graph illustrating a relationship between a shrink-fitting load and the rate of increase in iron loss.

FIG. 16 is a longitudinal-sectional view illustrating a stator core and a shell of a modification of the first embodiment.

FIG. 17 is a cross-sectional view illustrating a stator core and a shell of a second embodiment.

FIG. 18 is a longitudinal-sectional view illustrating a stator core and a shell of a third embodiment.

FIG. 19 is a longitudinal-sectional view illustrating a stator core and a shell of a fourth embodiment.

FIG. 20 is a longitudinal-sectional view illustrating a stator core and a shell of a fifth embodiment.

FIG. 21(A) is a diagram illustrating an inner circumferential surface of a shell of a sixth embodiment, and FIG. 21(B) is a diagram illustrating a surface roughness of the inner circumferential surface of the shell before a shrink-fitting step.

FIG. 22 is a cross-sectional view illustrating another configuration example of a stator core and the shell.

FIG. 23 is a sectional view illustrating a compressor to which the motor of each embodiment is applicable.

FIG. 24 is a diagram illustrating an air conditioner that includes the compressor illustrated in FIG. 23.

### DETAILED DESCRIPTION

### First Embodiment

### (Configuration of Motor)

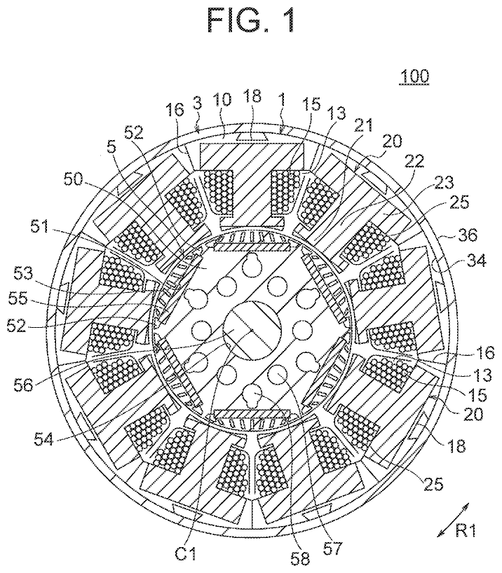

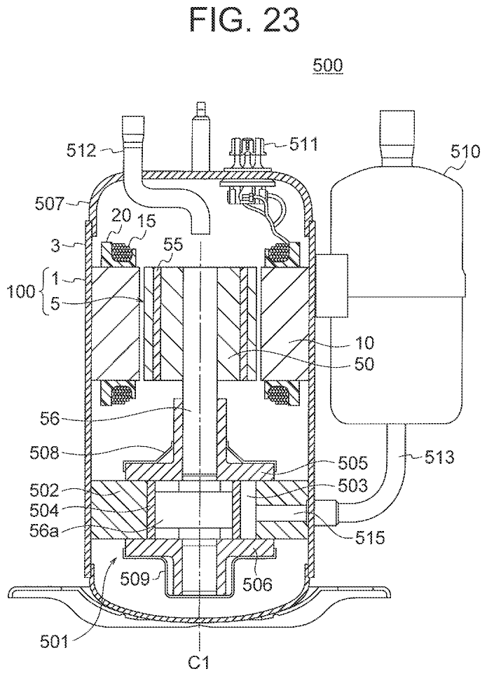

First, a motor 100 of a first embodiment will be described. FIG. 1 is a cross-sectional view illustrating the motor 100 of the first embodiment. The motor 100 is a permanent magnet embedded motor in which permanent magnets 55 are embedded in a rotor 5. The motor 100 is used in, for example, a compressor 500 (FIG. 23).

The motor 100 is a motor called an “inner rotor type” and includes the rotatable rotor 5, a stator 1 provided to surround the rotor 5, and an annular shell 3 in which the stator 1 is fixed. An air gap of, for example, 0.3 to 1.0 mm is famed between the stator 1 and the rotor 5.

Hereinafter, a direction of an axis C1, which is a rotating axis of the rotor 5, is simply referred to as an “axial direction”. A circumferential direction about the axis C1 (indicated by an arrow R1 in FIG. 1) is simply referred to as a “circumferential direction”. A radial direction about the axis C1 is simply referred to as a “radial direction”. A sectional view in a plane perpendicular to the axis C1 is referred to as a “cross-sectional view”. A sectional view in a plane parallel to the axis C1 is referred to as a “longitudinal-sectional view”.

### (Configuration of Rotor)

The rotor 5 includes a cylindrical rotor core 50, the permanent magnets 55 mounted in the rotor core 50, and a shaft 56 fixed to a central portion of the rotor core 50. The shaft 56 is, for example, a shaft of the compressor 500 (FIG. 23).

The rotor core 50 is famed of steel laminations which are stacked in the axial direction and integrated together by crimping or the like. Each of the steel laminations is, for example, an electromagnetic steel sheet. A sheet thickness of the steel lamination is, for example, 0.1 to 0.7 mm, and is 0.35 mm in this example. A shaft hole 54 is famed at a center of the rotor core 50 in the radial direction, and the above-described shaft 56 is fixed to the shaft hole 54.

A plurality of magnet insertion holes 51 into which the permanent magnets 55 are inserted are famed along an outer circumferential surface of the rotor core 50. Each magnet insertion hole 51 is famed from one end to the other end of the rotor core in the axial direction. Each magnet insertion hole 51 corresponds to one magnetic pole. The number of magnet insertion holes 51 is six in this example, and therefore the number of magnetic poles is six. The number of magnetic poles is not limited to six, and it is sufficient that the number of magnetic poles is two or more.

The magnet insertion hole 51 extends linearly in a plane perpendicular to the axis C1. One permanent magnet 55 is disposed in each magnet insertion hole 51. The permanent magnets 55 disposed in adjacent magnet insertion holes 51 are magnetized in such a manner that their opposite magnetic poles face outward in the radial direction.

The permanent magnet 55 is a flat plate-like member elongated in the axial direction. The permanent magnet 55 has a width in the circumferential direction of the rotor core 50 and a thickness in the radial direction. The thickness of the permanent magnet 55 is, for example, 2 mm. The permanent magnet 55 is famed of a rare earth magnet that contains, for example, neodymium (Nd), iron (Fe), and boron (B). The permanent magnet 55 is magnetized in the thickness direction.

The above-described rare earth magnet has a characteristic such that its coercive force decreases with increase in temperature. The rate of decrease in the coercive force is −0.5 to −0.6%/K. In order to prevent demagnetization of the rare earth magnet when the maximum load expected in the compressor is generated, a coercive force of 1100 to 1500 A/m is required. In order to ensure this coercive force at an ambient temperature of 150° C., the coercive force at a normal temperature (20° C.) needs to be in a range of 1800 to 2300 A/m.

Thus, dysprosium (Dy) may be added to the rare earth magnet. The coercive force of the rare earth magnet at the normal temperature is 1800 A/m when Dy is not added and is 2300 A/m when 2 wt% of Dy is added. However, the addition of Dy causes an increase in the manufacturing cost, and leads to a decrease in the residual magnetic flux density. Therefore, it is desirable to add as little Dy as possible or not to add Dy.

The magnet insertion hole 51 may be famed in a V shape such that its center in the circumferential direction protrudes inward in the radial direction. In this case, two permanent magnets 55 may be disposed in each magnet insertion hole 51.

A flux barrier 52 as a magnetic flux leakage suppression hole is formed at each of both end portions of the magnet insertion hole 51 in the circumferential direction. The flux barrier 52 is provided to suppress the magnetic flux leakage between adjacent magnetic poles. A core portion between the flux barrier 52 and the outer circumference of the rotor core 50 is a thin-walled portion for suppressing short circuit of the magnetic flux between the adjacent magnetic poles. A thickness of the thin-walled portion is desirably equal to the sheet thickness of the steel lamination of the rotor core 50.

Slits 53 are foamed on an outer side in the radial direction with respect to the magnet insertion hole 51. The slits 53 are used to smooth the distribution of magnetic flux from the permanent magnet 55 toward the stator 1 and to suppress torque ripple. The number, arrangement, and shapes of the slits 53 are not limited. The rotor core 50 does not necessarily have the slits 53.

Holes 57 and 58, which serve as passages for refrigerant in the compressor 500 (FIG. 23), are famed on the inner side in the radial direction with respect to the magnet insertion hole 51. Each hole 57 is famed at a position corresponding to a boundary between the magnetic poles, while each hole 58 is famed at a position corresponding to a pole center. However, the arrangement of the holes 57 and 58 may be changed appropriately.

### (Configuration of Stator)

The stator 1 includes a stator core 10, insulators 20 and insulating films 25 which are attached to the stator core 10, and coils 15 wound on the stator core 10 via the insulators 20 and the insulating films 25.

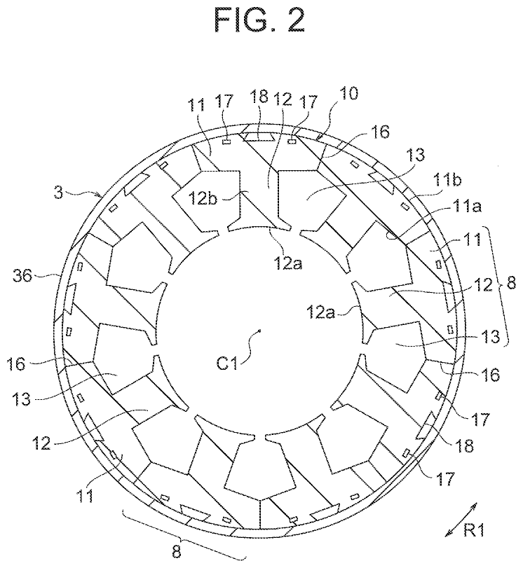

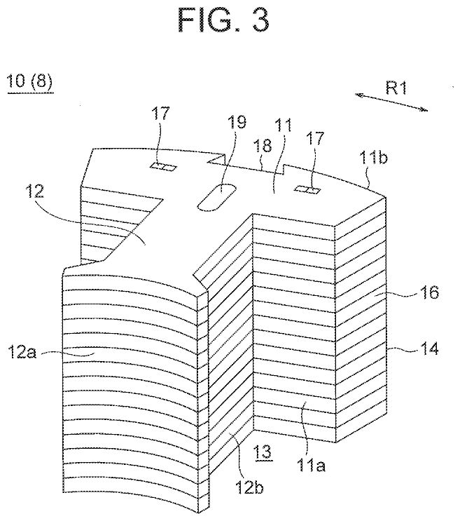

FIG. 2 is a cross-sectional view illustrating the stator core 10 and the shell 3. The stator core 10 is famed of steel laminations 14 (FIG. 3) which are stacked in the axial direction and fixed integrally by crimping portions 17. Each of the steel laminations 14 is, for example, an electromagnetic steel sheet. A sheet thickness of the steel lamination 14 is, for example, 0.1 to 0.7 mm, and is 0.35 mm in this example.

The stator core 10 has a yoke 11 having an annular shape about the axis C1 and a plurality of teeth 12 extending inward in the radial direction from the yoke 11. The yoke 11 has an inner circumferential surface 11a and an outer circumferential surface 11b. The outer circumferential surface 11b of the yoke 11 is fixed to an inner circumferential surface of the shell 3. The outer circumferential surface 11b of the yoke 11 fauns an outer circumferential surface of the stator core 10.

The teeth 12 are famed at equal intervals in the circumferential direction. Although the number of teeth 12 is nine in this example, it is sufficient that the number of teeth 12 is two or more. A slot 13 for accommodating the coils 15 is formed between adjacent teeth 12.

The stator core 10 is formed of a plurality of split cores 8 each of which includes one tooth 12 and which are connected in the circumferential direction. The number of the split cores 8 is, for example, nine. These split cores 8 are joined to each other at split surface portions 16 famed in the yoke 11. Each split surface portion 16 is famed, for example, at an intermediate position between two teeth 12 adjacent to each other in the circumferential direction.

The split cores 8 are joined to each other by welding at the split surface portions 16. The split cores 8 may be joined using other means than welding. For example, it is possible to foam concave and convex portions on the split surface portions 16, and to make the concave and convex portions to mate with each other.

FIG. 3 is a perspective view illustrating the split core 8. The tooth 12 has an extending portion 12b extending inward in the radial direction from the yoke 11, and a tooth tip portion 12a facing the rotor 5 (FIG. 1). A width of the extending portion 12b in the circumferential direction is constant in the radial direction. A width of the tooth tip portion 12a in the circumferential direction is wider than the width of the extending portion 12b. A side surface of the extending portion 12b of the teeth 12 and the inner circumferential surface 11a of the yoke 11 face the slot 13.

The crimping portions 17 are foamed in the yoke 11. The crimping portions 17 integrally fix the plurality of steel laminations 14 that constitute the split cores 8. The crimping portions 17 are famed at two positions that are symmetric with respect to a center of the tooth 12 in the circumferential direction. However, the number and arrangement of the crimping portions 17 may be changed appropriately.

A concave portion 18 is famed on the outer circumferential surface 11b of the yoke 11 at a position corresponding to the center of the tooth 12 in the circumferential direction. The concave portion 18 is a portion with which a crimping portion 34 (FIG. 11) of the shell 3 engages, and also functions as a passage for refrigerant in the compressor 500 (FIG. 23).

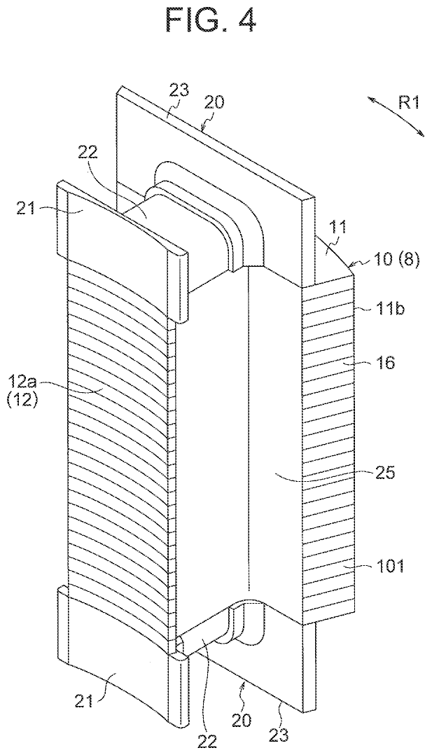

FIG. 4 is a perspective view illustrating the split core 8 and the insulators 20 and the insulating films 25 which are attached to the split core 8. The insulators 20 are attached to both ends of the stator core 10 in the axial direction. The insulator 20 is famed of, for example, a resin such as polybutylene terephthalate (PBT).

Each insulator 20 has a wall portion 23 attached to the yoke 11, a body portion 22 attached to the extending portion 12b (FIG. 3) of the tooth 12, and a flange portion 21 attached to the tooth tip portion 12a.

The coil 15 (FIG. 1) is wound around the body portion 22. The flange portion 21 and the wall portion 23 guide the coil 15, which is wound around the body portion 22, from both sides of the coil 15 in the radial direction. The flange portion 21 and the wall portion 23 may be provided with step portions for positioning the coil 15 wound around the body portion 22.

A hole 19 (FIG. 3) is foamed at each of both ends of the tooth 12 in the axial direction. Each insulator 20 has a protrusion that is fitted into the hole 19. By fitting the protrusion of the insulator 20 into the hole 19 of the tooth 12, the insulator 20 is fixed to the tooth 12.

The insulating film 25 is attached to the side surface of the extending portion 12b (FIG. 3) of the tooth 12 and the inner circumferential surface 11a (FIG. 3) of the yoke 11. The insulating film 25 is famed of, for example, a resin such as polyethylene terephthalate (PET). The insulator 20 and the insulating film 25 constitute an insulating portion that electrically insulates the stator core 10 from the coils 15.

In FIG. 1, the coil 15 is famed of, for example, a magnet wire, and wound around the tooth 12 via the insulators 20 and the insulating films 25. A wire diameter of the coil 15 is, for example, 1.0 mm. The coil 15 is wound around each of the teeth 12 by, for example, 80 turns, by concentrated winding. The wire diameter and the number of turns of the coil 15 are determined depending on a required rotation speed, torque, applied voltage, or an area of each slot 13.

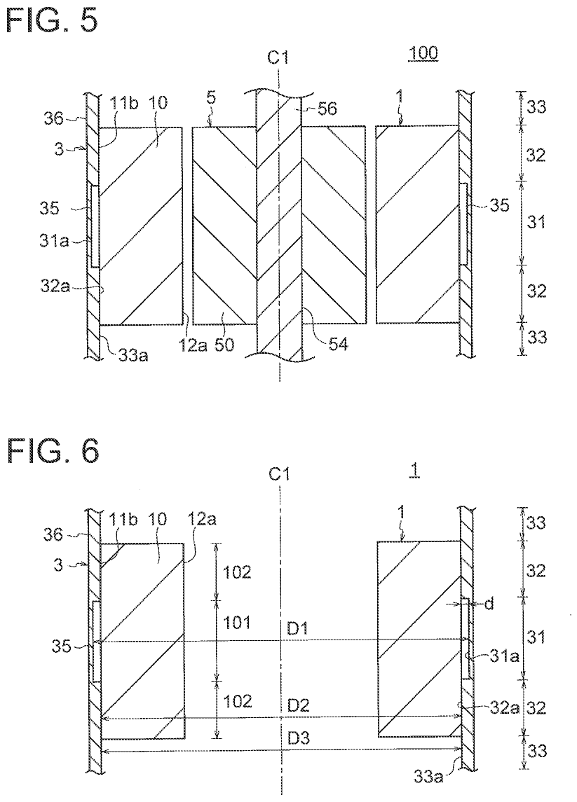

FIG. 5 is a longitudinal-sectional view illustrating the motor 100. The stator 1 is fixed inside the annular shell 3. More specifically, the stator core 10 of the stator 1 is fitted into the shell 3 by shrink-fitting or press-fitting. The shell 3 is a part of a sealed container 507 of the compressor 500 (FIG. 23) in which the motor 100 is mounted. A length of the shell 3 in the axial direction is longer than a length of the stator 1 in the axial direction.

FIG. 6 is a longitudinal-sectional view illustrating the stator core 10 and the shell 3. The shell 3 has a first shell portion 31, second shell portions 32, and third shell portions 33 in the axial direction. The first shell portion 31 faces the stator core 10 in the radial direction and has an inner diameter Dl. Each of the second shell portions 32 contacts the stator core 10 and has an inner diameter D2 smaller than the inner diameter Dl. Each of the third shell portions 33 protrudes from the stator core 10 in the axial direction and has an inner diameter D3 smaller than the inner diameter D1.

The first shell portion 31 is formed at a position corresponding to a central portion of the stator core 10 in the axial direction. The second shell portions 32 are famed at both sides of the first shell portion 31 in the axial direction. The third shell portions 33 are formed at both sides of the second shell portions 32 in the axial direction.

An inner circumferential surface 31a of the first shell portion 31 is distanced from the outer circumferential surface llb of the stator core 10 in the radial direction. An inner circumferential surface 32a of the second shell portion 32 contacts the outer circumferential surface 11b of the stator core 10 in the radial direction. An inner circumferential surface 33a of the third shell portion 33 does not face the outer circumferential surface 11b of the stator core 10 in the radial direction.

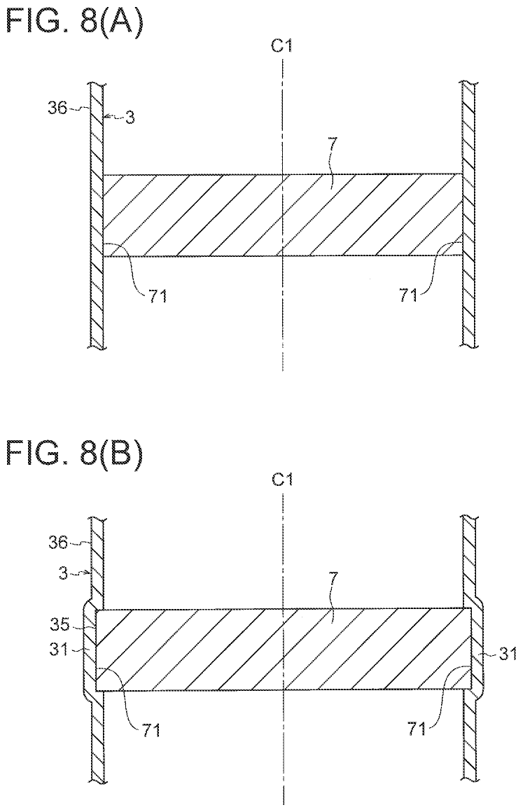

The first shell portion 31 is obtained by foaming a concave portion 35 on the inner circumferential surface of the shell 3. The concave portion 35 is foamed, for example, by perfoLming cutting on the inner circumferential side of the cylindrical shell having a constant thickness. Instead of cutting, a tube expansion process (FIGS. 8(A) and (B)) described later may be used. The concave portion 35 has a depth “d” in a radial direction about the axis C1. The depth “d” is constant in the axial direction in this example, but may not necessarily be constant.

An outer circumferential surface 36 of the shell 3 is a cylindrical surface in this example. However, in the case where the concave portion 35 is famed by the tube expansion process, the outer circumferential surface 36 has a shape such that a part thereof in the first shell portion 31 protrudes outward in the radial direction (see FIG. 8(B)).

The stator core 10 includes, in the axial direction, a first core portion 101 facing the first shell portion 31 in the radial direction and second core portions 102 contacting the second shell portions 32. The first core portion 101 is located at the central portion of the stator core 10 in the axial direction. The second core portions 102 are located at both sides of the first core portion 101 in the axial direction. The first core portion 101 and the second core portions 102 each are composed of the steel laminations having the same shape, and they have the same outer diameter.

As described above, the stator core 10 is fitted into the shell 3 by shrink-fitting or press-fitting. Specifically, the second core portions 102 of the stator core 10 are fitted in the second shell portion 32 of the shell 3. The first core portion 101 of the stator core 10 faces the first shell portion 31 of the shell 3, but does not contact the first shell portion 31. Thus, the first core portion 101 is applied with no compressive stress by the shell 3. Therefore, the change in magnetic properties due to the compressive stress is suppressed, and iron loss is reduced.

### (Manufacturing Method of Motor)

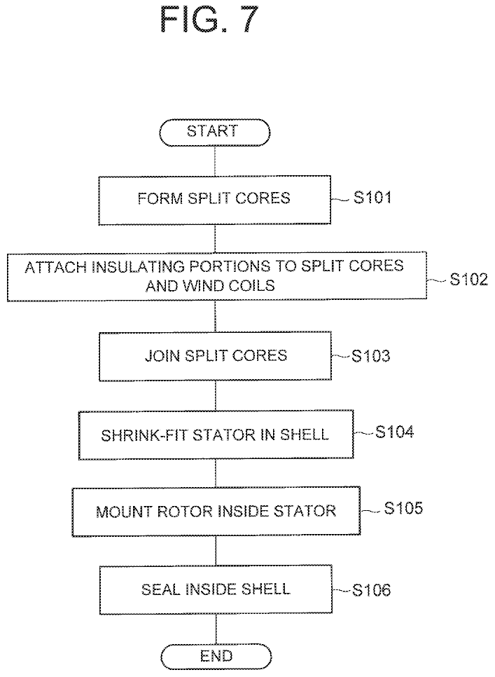

Next, a manufacturing method of the motor 100 will be described. FIG. 7 is a flowchart illustrating the manufacturing process of the motor 100. First, a plurality of steel laminations are stacked in the axial direction and integrally fixed together by the crimping portions 17 to foam the split cores 8 illustrated in FIG. 3 (step S101). Then, the insulators 20 and the insulating films 25 (FIG. 3) as the insulating portions are attached to the split cores 8, and then the coils 15 are wound around the teeth 12 via the insulating portions (step S102). Further, the plurality of split cores 8 are joined together by welding or the like to thereby foam the stator core 10 (step S103). In this way, the stator 1 is famed.

Meanwhile, the concave portion 35 is famed in advance in the shell 3 to which the stator 1 is attached. As described above, the concave portion 35 is famed by performing cutting on the inner circumferential surface of the cylindrical shell 3. However, the formation of the concave portion 35 is not limited to the cutting, but the tube expansion process may be used.

FIGS. 8(A) and 8(B) are schematic diagrams for explaining the tube expansion process. In the tube expansion process, as illustrated in FIG. 8(A), a disc-shaped tool 7 is fitted into a part of the shell 3 where the concave portion 35 is to be famed. Then, as illustrated in FIG. 8(B), the tool 7 is heated and expanded. Consequently, an outer circumferential edge 71 of the tool 7 presses the shell 3 outward in the radial direction, whereby the shell 3 is plastically deformed outward in the radial direction. Thereafter, the tool 7 is cooled with air and then pulled out of the shell 3. In this way, the concave portion 35 is famed in the shell 3.

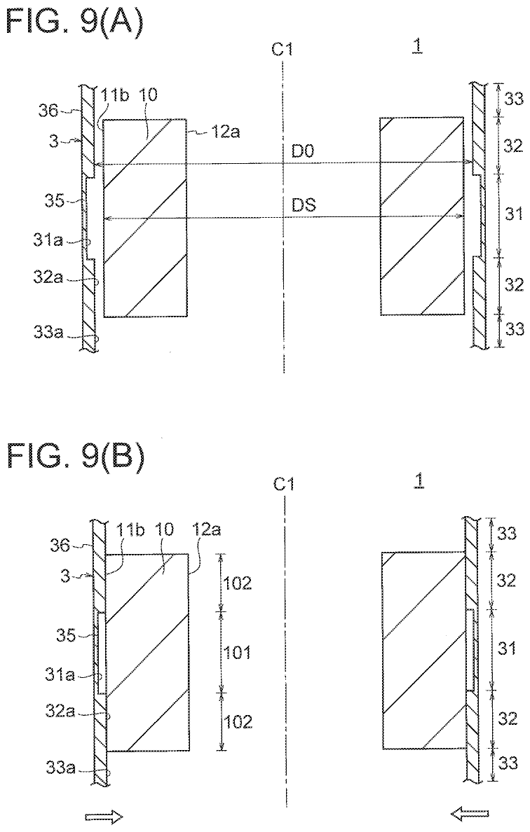

The stator 1 is fixed by shrink-fitting to the shell 3 having the concave portion 35 formed as above (step S104). FIGS. 9(A) and 9(B) are schematic diagrams for explaining a shrink-fitting process. In the shrink-fitting process, as illustrated in FIG. 9(A), the shell 3 is heated and thermally expanded, thereby making an inner diameter D0 of the shell 3 larger than an outer diameter DS of the stator core 10. In this state, the stator 1 is inserted in the shell 3.

Thereafter, the shell 3 is cooled, so that the inner diameter of the shell 3 decreases as illustrated in FIG. 9(B). Thus, the outer circumferential surface 11b of the stator core 10 is fitted to the inner circumferential surface of the shell 3.

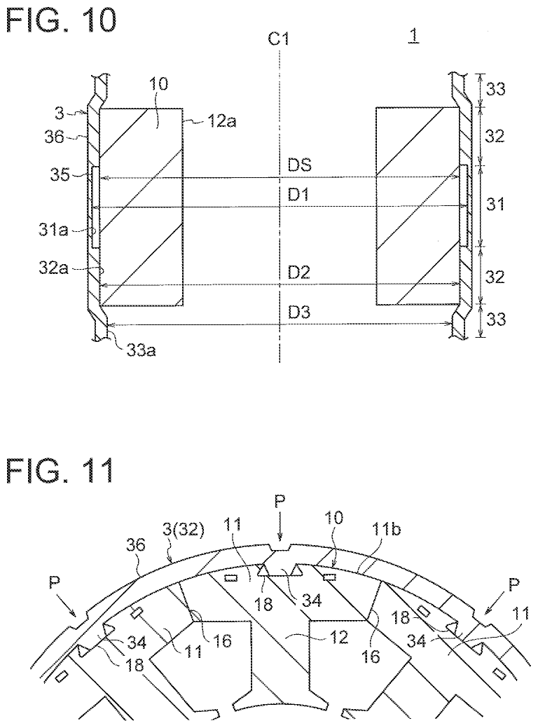

FIG. 10 is a diagram illustrating the stator 1 and the shell 3 after the shrink-fitting. Since each second shell portion 32 contacts the stator core 10, the inner diameter D2 of the second shell portion 32 is the same as the outer diameter DS of the stator core 10. Meanwhile, since each third shell portion 33 does not contact the stator core 10, the inner diameter D3 of the third shell portion 33 can be smaller than or equal to the outer diameter DS of the stator core 10.

Therefore, as illustrated in FIG. 10, the inner diameter D3 of the third shell portion 33 is smaller than or equal to the inner diameter D2 of the second shell portion 32 (D2≥D3), and more preferably smaller than the inner diameter D2 (D2>D3). Thus, the third shell portion 33 effectively functions as a retainer that prevents the stator 1 from being pulled out from the shell 3 in the axial direction.

The configuration retaining the stator 1 is not limited to the configuration illustrated in FIG. 10. The retaining effect of the stator 1 can be expected to some extent as long as the inner diameter D3 of the third shell portion 33 is smaller than the inner diameter D1 of the first shell portion 31 (D1>D3).

Although the case in which the stator core 10 is fitted into the shell 3 by the shrink-fitting has been described herein, it is also possible to use, for example, the press-fitting instead of the shrink-fitting.

As illustrated in FIG. 11, fitting portions between the stator core 10 and the shell 3 are desirably fixed by thermal crimping. In this example, parts of the second shell portion 32 of the shell 3 which correspond to the concave portions 18 of the stator core 10 are applied with heat and force P from the outer circumferential surface 36. In this way, the parts of the shell 3 are defamed inward in the radial direction to foam the crimping portions 34. The crimping portions 34 are engaged with the concave portions 18 of the stator core 10.

The engagement of the crimping portions 34 of the shell 3 with the concave portions 18 of the stator core 10 prevents misalignment between the shell 3 and the stator 1 in the circumferential direction. It is desirable to perform thermal crimping at the positions corresponding to all of the concave portions 18, but it is sufficient to perform thermal crimping at least at one position of the stator core 10 in the circumferential direction.

Meanwhile, the rotor 5 is foamed by stacking the plurality of steel laminations in the axial direction to foam the rotor core 50 and then inserting the permanent magnets 55 into the magnet insertion holes 51. The rotor 5 is mounted on an inner side of the stator 1 fixed to the shell 3 (step S105 in FIG. 7). Then, the shell 3 is sealed (step S106). Thus, the motor 100 including the stator 1, the rotor 5, and the shell 3 is completed.

### (Action)

Next, the action of the motor 100 of the first embodiment will be described. An energy consumed in a core such as a stator core when the magnetic flux in the core changes is referred to as an iron loss. Most of the iron loss in the motor 100 is an iron loss in the stator core 10 because the change in the magnetic flux in the rotor core 50 is small. The iron loss is expressed by a sum of a hysteresis loss and an eddy current loss. The hysteresis loss is proportional to a frequency of the change in the magnetic flux, and the eddy current loss is proportional to a square of the frequency.

In the motor 100 having the permanent magnets 55, the ratio of the iron loss in the total loss is large, as compared to a motor having no permanent magnet such as an induction motor. That is, when the magnetic flux generated by the permanent magnets 55 flows through the stator core 10, the iron loss occurs depending on the change in the magnetic flux.

When a current is applied to the coils 15, the magnetic flux generated by the permanent magnets 55 and the magnetic flux generated by the current flowing through the coils 15 superpose each other to generate a high-frequency magnetic flux component. As described above, the hysteresis loss is proportional to the frequency of the change in the magnetic flux while the eddy current loss is proportional to the square of the frequency. Thus, the iron loss increases with an increase in the frequency of the change in the magnetic flux.

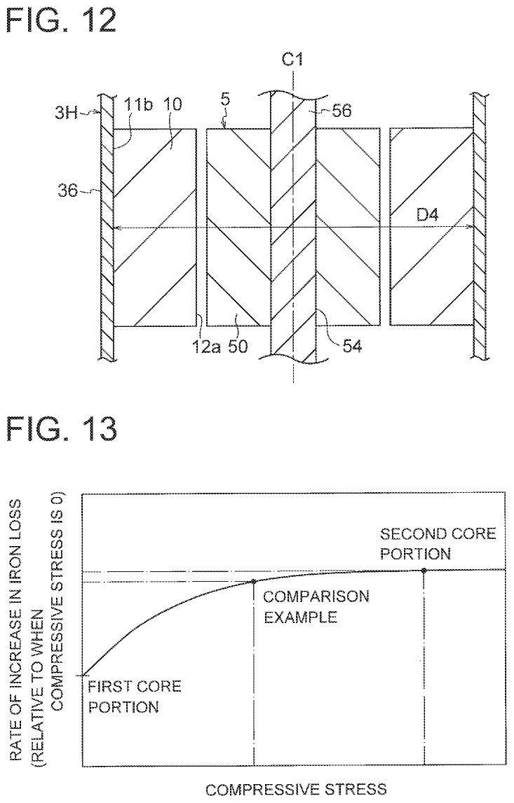

FIG. 12 is a longitudinal-sectional view illustrating a motor of a comparison example, which is compared to the motor 100 of the first embodiment. In the motor of the comparison example, a shell 3H does not have the concave portion 35 (FIG. 5) described in the first embodiment, and an inner diameter D4 of the shell 3H is constant in the axial direction. Thus, the outer circumferential surface 11b of the stator core 10 entirely contacts the shell 3H.

The stator core 10 is fitted into the shell 3H by shrink-fitting or press-fitting, and the stator core 10 is applied with a compressive stress by the shell 3H. The product of a contact area between the stator core 10 and the shell 3H and an average stress acting on the contact area is referred to as a shrink-fitting load. The shrink-fitting load is an index of a fixing force with which the stator core 10 is fixed to the shell 3H.

When a core material such as the electromagnetic steel sheet forming the stator core 10 is applied with a compressive stress, magnetic properties of the core material change, leading to an increase in the iron loss. In the motor of the comparison example illustrated in FIG. 12, the outer circumferential surface 11b of the stator core 10 is entirely fitted to the shell 3H, and thus the iron loss increases entirely in the stator core 10, so that motor efficiency decreases.

In contrast, in the motor 100 of the first embodiment, as illustrated in FIG. 6, the first core portion 101 of the stator core 10 does not contact the shell 3 and thus is applied with no compressive stress, so that the iron loss in the first core portion 101 hardly increases. Thus, the motor efficiency is improved as compared to the motor of the comparison example.

Here, the effect of reducing the iron loss according to the first embodiment will be described using specific numerical values. It is assumed that the iron loss per unit volume in the stator core 10 of the motor of the comparison example before shrink-fitting or press-fitting is 1. Further, it is assumed that the iron loss in the stator core 10 increases to 2 by the shrink-fitting or press-fitting.

In the motor 100 of the first embodiment, it is assumed that the length of the first core portion 101 accounts for 50% of the length of the stator core 10 in the axial direction. In this case, the contact area between the stator core 10 and the shell 3 is half the contact area in the comparison example. Assuming that the shrink-fitting load in the first embodiment is the same as that in the comparison example, the second core portion 102 is applied with the compressive stress which is twice as large as that in the comparison example.

Since the first core portion 101 is applied with no compressive stress by the shell 3, it can be considered that the iron loss per unit volume in the first core portion 101 is 1. In contrast, the second core portion 102 is applied with the compressive stress by the shell 3, and the magnitude of this compressive stress is twice as large as that in the comparison example.

FIG. 13 is a graph illustrating a relationship between the compressive stress applied to the stator core 10 and the rate of increase in iron loss per unit volume in the stator core 10. The rate of increase in iron loss is a relative value of the iron loss relative to an iron loss (i.e., 1) when the compressive stress is zero. The iron loss per unit volume in the stator core 10 of the comparison example is 2 as described above.

As illustrated in FIG. 13, as the compressive stress increases, the iron loss also increases, but the rate of increase in iron loss is gradually saturated. Thus, in the first embodiment, the iron loss is saturated in the second core portion 102 where the compressive stress is large. As a result, the iron loss per unit volume in the second core portion 102 is smaller than twice that in the comparison example.

It is assumed that the iron loss per unit volume in the second core portions 102 is 2.4 which is 1.2 times as large as that in the comparison example. The first core portion 101 accounts for 50% of the stator core 10 and the second core portions 102 account for 50% of the stator core 10. In this case, the average iron loss per unit volume of the stator core 10 is (2.4×0.5)+(1×0.5)=1.7. This value is smaller than the iron loss (=2) per unit volume of the stator core 10 of the comparison example. That is, it is understood that the motor 100 of the first embodiment provides the effect of reducing the iron loss.

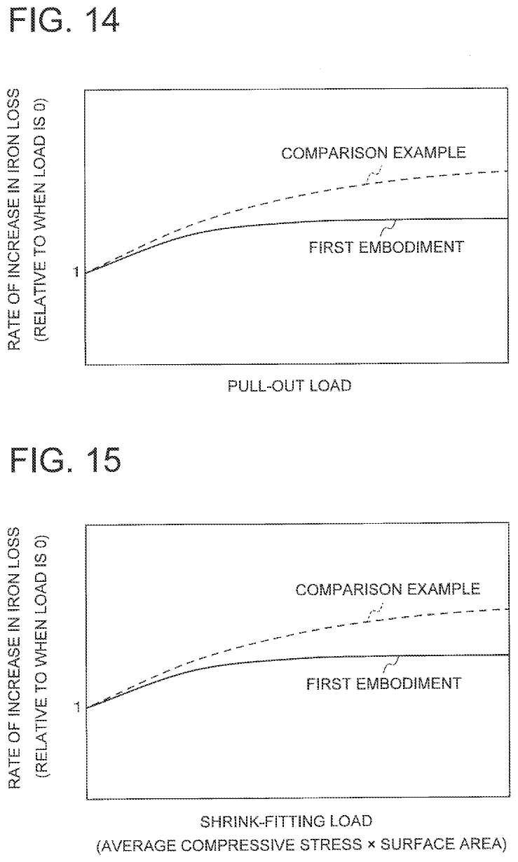

FIG. 14 is a graph illustrating a relationship between a pull-out load and the rate of increase in iron loss per unit volume in the stator core 10. The pull-out load refers to a load required to pull the stator 1 out of the shell 3 in the axial direction. FIG. 15 is a graph illustrating a relationship between the shrink-fitting load and the rate of increase in iron loss per unit volume in the stator core 10. In both graphs, the rate of increase in iron loss is a relative value of the iron loss relative to the iron loss (i.e., 1) when the compressive stress is zero.

As is clear from FIGS. 14 and 15, the iron loss shows the similar tendency to the pull-out load and the shrink-fitting load. In the stator core 10 of the first embodiment, the stress is concentrated on the second core portions 102, and thus the iron loss is saturated at the pull-out load and the shrink-fitting load which are smaller than those in the stator core 10 of the comparison example. The increase in the iron loss is small with respect to the increase in the pull-out load and the shrink-fitting load.

Therefore, according to the first embodiment, the increase in the iron loss can be suppressed, and the stator core 10 can be firmly fixed to the shell 3. In other words, the iron loss in the stator core 10 can be reduced by means of the saturation of the iron loss caused by the concentration of stress on the second core portions 102.

Further, in the motor 100 of the first embodiment, both end portions of the stator core 10 in the axial direction are fitted into the shell 3. Thus, the stator 1 can be supported in a stable state, so that vibration and noise can be suppressed.

The stator core 10 is foiled of a stacked body of steel laminations and is likely to be defamed in the stacking direction, i.e., the axial direction because gaps between the steel laminations are extended or contracted. By fitting both end portions of the stator core 10 in the axial direction into the shell 3, the defamation of the stator core 10 in the axial direction is suppressed, so that vibration and noise can be suppressed.

The magnetic flux from the rotor 5 is more likely to flow into the first core portion 101 located at the central portion of the stator core 10 in the axial direction. Thus, a magnetic flux density in the first core portion 101 is higher than a magnetic flux density in each of the second core portion 102 located at both end portions of the stator core in the axial direction. Since the first core portion 101 faces the first shell portion 31 of the shell 3 and is applied with no compressive stress, the effect of reducing the iron loss can be enhanced.

Since the compressive stress is concentrated on the second core portion 102 as described above, the adhesion between the shell 3 and the second core portion 102 can be enhanced. Thus, when the shell 3 and the stator core 10 are fixed using thermal crimping (FIG. 11) or arc welding (FIG. 17), the fixing force can be enhanced. Furthermore, since the crimping or arc welding is utilized, the stator core 10 can be fitted into the shell 3 with a smaller shrink-fitting load, and the effect of reducing the iron loss can be further enhanced.

Since the stator core 10 is famed of the plurality of split cores 8, it is easy to wind the coils 15 around the teeth 12 at high density, but it is difficult to improve a circularity of the stator core 10. In the first embodiment, the second core portion 102 of the stator core 10 is applied with a high compressive stress, and thus the stator core 10 is strongly tightened. Thus, the adjacent split cores 8 are strongly pressed against each other, and are positioned at accurate relative positions. As a result, the circularity of the stator core 10 can be improved.

### Effects of Embodiment

As described above, in the first embodiment, the shell 3 includes the first shell portion 31 facing the stator core 10 in the radial direction, the second shell portion 32 contacting the stator core 10 in the radial direction, and the third shell portion 33 protruding from the stator core 10 in the axial direction. The inner diameters D1, D2, and D3 of the shell portions 31, 32, and 33 satisfy D1>D2 and D1>D3. Thus, the stator core 10 is firmly fixed to the shell 3 by the contact between the second shell portion 32 and the stator core 10. Since the stator core 10 is applied with no compressive stress by the first shell portion 31, the iron loss in the stator core 10 can be reduced, thereby improving the motor efficiency. Further, the stator core 10 can be prevented from being pulled out from the shell 3 by the third shell portion 33.

Furthermore, the inner diameters D2 and D3 of the second shell portion 32 and the third shell portion 33 satisfy D2≥D3, and thus the stator core 10 can be effectively prevented from being pulled out from the shell 3.

Since the first shell portion 31 of the shell 3 has the concave portion 35 on the side facing the stator core 10, the shell 3 that satisfies D1>D2 can be famed by a simple process such as cutting.

Since the stator core 10 and the shell 3 are fixed to each other by the thermal crimping (the crimping portions 34), the fixing strength between the stator core 10 and the shell 3 can be enhanced.

With the configuration in which the stator core 10 is tightened by the second shell portions 32 of the shell 3, a high circularity can be achieved even when the stator core 10 is formed of the plurality of split cores 8.

The first shell portion 31 of the shell 3 is famed at the position corresponding to the central portion of the stator core 10 in the axial direction in which the magnetic flux from the rotor 5 flows most, and thus the effect of reducing the iron loss can be enhanced.

Since the second shell portion 32 of the shell 3 contact the end portion of the stator core 10 in the axial direction, the defamation of the stator core 10 is suppressed, and vibration and noise can be reduced.

### Modification

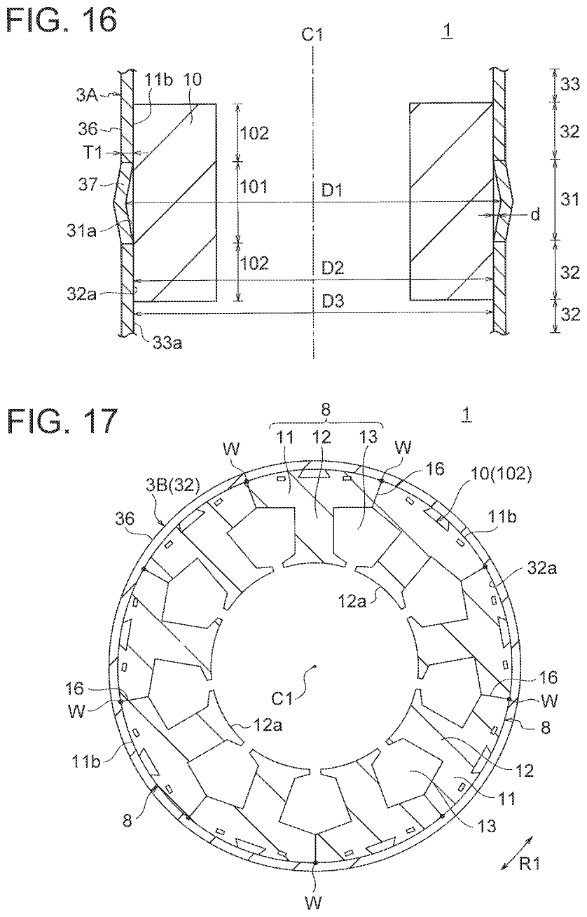

FIG. 16 is a longitudinal-sectional view illustrating the stator core 10 and a shell 3A of a modification of the first embodiment. In the above-described first embodiment, the depth “d” of the concave portion 35 (FIG. 6) of the first shell portion 31 is constant in the axial direction. In contrast, the depth “d” of a concave portion 37 in the first shell portion 31 of the modification varies in the axial direction.

More specifically, the concave portion 37 has the maximum depth “d” at its center in the axial direction. However, the position where the depth “d” of the concave portion 37 is the maximum is not limited to the center of the concave portion 37 in the axial direction, but may be, for example, an end of the concave portion 37 in the axial direction. The concave portion 37 can be famed by the cutting or the tube expansion process as described in the first embodiment.

Also in the modification, the first shell portion 31 of the shell 3A has the concave portion 37, and the concave portion 37 does not contact the stator core 10. Thus, no compressive stress is applied to the first core portion 101 of the stator core 10, and the iron loss in the stator core 10 can be reduced.

### Second Embodiment

FIG. 17 is a cross-sectional view illustrating the stator core 10 and a shell 3B of a second embodiment. In the first embodiment described above, the fitting portions between the stator core 10 and the shell 3 are fixed by the thermal crimping as illustrated in FIG. 11. In the second embodiment, fitting portions between the stator core 10 and the shell 3B are fixed by arc spot welding.

The stator core 10 is foiled of the plurality of split cores 8 as described in the first embodiment. The arc spot welding is performed at intersections between the split surface portions 16 of the split core 8 and the inner circumferential surface 32a of the second shell portion 32 of the shell 3B. Thus, welding portions W are formed at intersections between the split surface portions 16 and the inner circumferential surface 32a of the shell 3B.

The stator core 10 is tightened strongly by the second shell portions 32 as described in the first embodiment, and thus the fixing strength between the stator core 10 and the shell 3B by the arc spot welding can be enhanced.

The motor of the second embodiment is configured in a similar manner to the motor 100 of the first embodiment except for the points described above.

In the second embodiment, the stator core 10 and the shell 3B are fixed to each other by the arc spot welding, and thus the fixing strength between the stator core 10 and the shell 3B can be enhanced.

### Third Embodiment

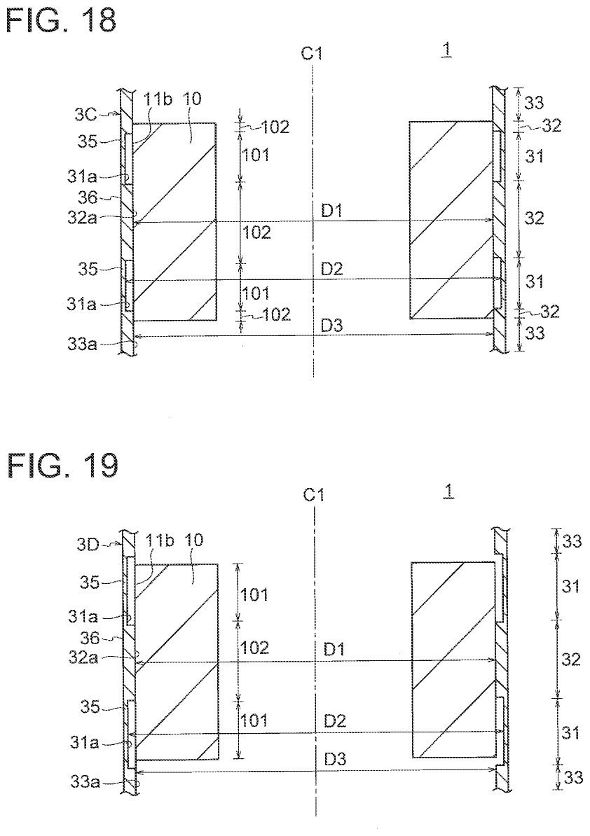

FIG. 18 is a longitudinal-sectional view illustrating the stator core 10 and a shell 3C of a third embodiment. In the first embodiment described above, the first shell portion 31 of the shell 3 is famed at the position corresponding to the central portion of the stator core 10 in the axial direction, while the second shell portions 32 are famed at the positions corresponding to both end portions of the stator core 10 in the axial direction.

The shell 3C of the third embodiment has second shell portions 32 at positions that correspond to the central portion of the stator core 10 in the axial direction and both end portions of the stator core 10 in the axial direction. In other words, the shell 3C contacts the central portion of the stator core 10 in the axial direction and both end portions of the stator core 10 in the axial direction.

The shell 3C has first shell portions 31 at both sides in the axial direction of the second shell portion 32 located at the central portion of the shell 3C in the axial direction. Each first shell portion 31 is obtained by foaming the concave portion 35 on an inner circumference of the shell 3C. Instead of the concave portion 35, the concave portion 37 illustrated in FIG. 16 may be famed.

The stator core 10 has first core portions 101 facing the first shell portions 31 in the radial direction and second core portions 102 contacting the second shell portions 32. The second core portions 102 are located at the central portion and both end portions of the stator core 10 in the axial direction, while the first core portions 101 are located at both sides in the axial direction of the second core portion 102 located at the central portion of the stator core 10 in the axial direction.

That is, in the third embodiment, the central portion and both end portions of the stator core 10 in the axial direction are fitted into the shell 3C. Fitting portions between the stator core 10 and the shell 3C may be fixed by thermal crimping as illustrated in FIG. 11 or by arc spot welding illustrated in FIG. 17.

The motor of the third embodiment is configured in a similar manner to the motor 100 of the first embodiment except for the points described above.

In the third embodiment, the central portion and both end portions of the stator core 10 in the axial direction are fitted into the shell 3C. Consequently, the stator core 10 is firmly fixed to the shell 3C, and thus the deformation of the stator core 10 can be suppressed, so that vibration and noise can be suppressed. Since the stator core 10 is applied with no compressive stress by the first shell portions 31, the iron loss in the stator core 10 can be suppressed.

### Fourth Embodiment

FIG. 19 is a longitudinal-sectional view illustrating the stator core 10 and a shell 3D of a fourth embodiment. In the first embodiment described above, the first shell portion 31 of the shell 3 is famed at the position corresponding to the central portion of the stator core 10 in the axial direction, while the second shell portions 32 are foamed at the positions corresponding to both end portions of the stator core 10 in the axial direction.

The shell 3D of the fourth embodiment has a second shell portion 32 at the central portion of the stator core 10 in the axial direction. In other words, the shell 3D contacts the central portion of the stator core 10 in the axial direction.

The shell 3D has the first shell portions 31 at both sides of the second shell portion 32 in the axial direction. Each first shell portion 31 is obtained by foaming the concave portion 35 on the inner circumference of the shell 3D. Instead of the concave portion 35, the concave portion 37 illustrated in FIG. 16 may be famed.

The stator core 10 has first core portions 101 facing the first shell portions 31 in the radial direction and a second core portion 102 contacting the second shell portion 32. The second core portion 102 is located at the central portion of the stator core 10 in the axial direction, while the first core portions 101 are located at both sides of the second core portion 102 in the axial direction.

That is, in the fourth embodiment, the central portion of the stator core 10 in the axial direction is fitted into the shell 3D. Fitting portions between the stator core 10 and the shell 3D may be fixed by theLmal crimping as illustrated in FIG. 11 or by arc spot welding illustrated in FIG. 17.

The motor of the fourth embodiment is configured in a similar manner to the motor 100 of the first embodiment except for the points described above.

In the fourth embodiment, the central portion of the stator core 10 in the axial direction is fitted into the shell 3D, and thus the stress is concentrated on the central portion of the stator core 10 in the axial direction, so that the stator core 10 can be firmly fixed to the shell 3D. Since the stator core 10 is applied with no compressive stress by the first shell portions 31, the iron loss in the stator core 10 can be reduced.

### Fifth Embodiment

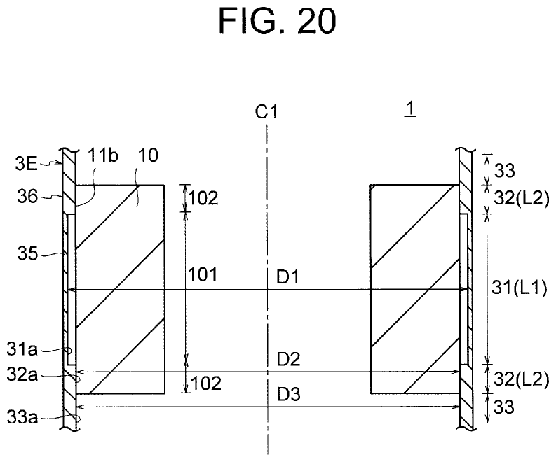

FIG. 20 is a longitudinal-sectional view illustrating the stator core 10 and a shell 3E of a fifth embodiment. In the fifth embodiment, as in the above-described first embodiment, the first shell portion 31 of the shell 3E is formed at the position corresponding to the central portion of the stator core 10 in the axial direction, while the second shell portions 32 are famed at the positions corresponding to both end portions of the stator core 10 in the axial direction. The first shell portion 31 is obtained by foaming the concave portion 35 on an inner circumferential surface of the shell 3E. Instead of the concave portion 35, the concave portion 37 illustrated in FIG. 16 may be famed.

The stator core 10 has a first core portion 101 facing the first shell portion 31 in the radial direction and second core portions 102 contacting the second shell portion 32. The first core portion 101 is located at the central portion of the stator core 10 in the axial direction, while the second core portions 102 are located at both sides of the stator core 10 in the axial direction.

The first shell portion 31 has a length L1 in the axial direction. Each of the two second shell portions 32 has a length L2 in the axial direction. The length L1 of the first shell portion 31 is longer than a sum of the lengths L2 of the second shell portions 32, i.e., L2×2. That is, L1>L2×2 is satisfied. In other words, an area of the inner circumferential surface 31a of the first shell portion 31 is larger than a total area of the inner circumferential surfaces 32a of the second shell portions 32.

The above-described length L1 is also the length of the first core portion 101 in the axial direction. The above-described length L2 is also the length of the second core portion 102 in the axial direction. Thus, the length L1 of the first core portion 101 is longer than a sum of the lengths L2 of the second core portions 102, i.e., L2×2. An area of the outer circumferential surface of the first core portion 101 is larger than a total area of the outer circumferential surfaces of the second core portions 102.

In this way, the area of the inner circumferential surface 31a of the first shell portion 31, i.e., the area of a surface of the shell 3E which does not contact the stator core 10, is large. Thus, the effect of reducing the iron loss can be enhanced. Further, the area of the inner circumferential surface 32a of the second shell portion 32, i.e., the area of a surface of the shell 3E which contacts the stator core 10, is small. Thus, the compressive stress can be concentrated, and the stator core 10 can be firmly fixed to the shell 3E.

The motor of the fifth embodiment is configured in a similar manner to the motor 100 of the first embodiment except for the points described above.

In the fifth embodiment, the area of the inner circumferential surface 31a of the first shell portion 31 is larger than the area of the inner circumferential surfaces 32a of the second shell portions 32, and thus the effect of reducing the iron loss can be enhanced. Further, the stator core 10 can be firmly fixed to the shell 3E by the concentration of the compressive stress.

The shell portions 31 and 32 of the shell 3E may be arranged as described in the third embodiment (FIG. 18) and the fourth embodiment (FIG.19). Also in this case, it is sufficient that the total area of the surface of the stator core 10 facing the shell 3E is larger than the total area of the surface of the stator core 10 contacting the shell 3E. Fitting portions between the stator core 10 and the shell 3E may be fixed by thermal crimping or arc spot welding.

### Sixth Embodiment

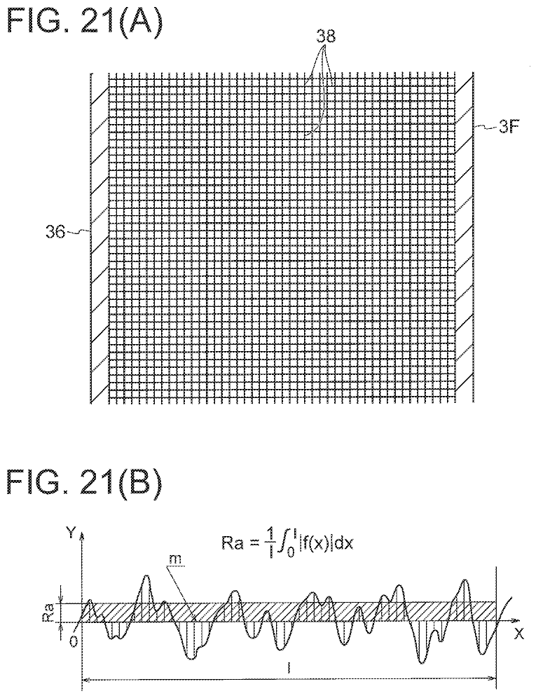

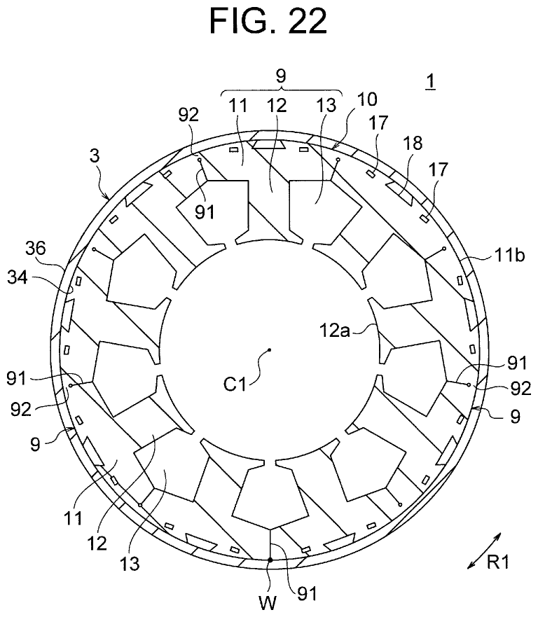

FIG. 21(A) is a front view illustrating an inner circumferential surface of a shell 3F of a sixth embodiment. In the above-described first embodiment, the concave portion 35 (FIG. 6) is foamed in the first shell portion 31 of the shell 3. In contrast, in the sixth embodiment, a plurality of grooves 38 are famed on the inner circumferential surface of the shell 3F. The grooves 38 are famed in a grid pattern that extends in the axial and circumferential directions in this example, but the grooves 38 are not limited to this pattern.

The grooves 38 of the shell 3F do not contact the outer circumferential surface of the stator core 10. That is, the stator core 10 is applied with no compressive stress by the grooves 38 of the shell 3F. Therefore, the effect of reducing the iron loss in the stator core 10 can be obtained.

In the sixth embodiment, the grooves 38 of the inner circumferential surface of the shell 3F constitute the first shell portion 31, while portions of the inner circumferential surface of the shell 3F other than the grooves 38 constitute the second shell portion 32. The third shell portion 33 (FIG. 6) is as described in the first embodiment.

The motor of the sixth embodiment is configured in a similar manner to the motor 100 of the first embodiment except for the points described above.

Instead of foaming the grooves 38 on the inner circumferential surface of the shell 3F, the surface of the inner circumferential surface of the shell 3F may be roughened to foam concave and convex portions. Since concave portions of the concave and convex portions do not contact the outer circumferential surface of the stator core 10, the effect of reducing the iron loss can be obtained. FIG. 21(B) is a diagram illustrating an example of a surface roughness of the concave and convex portion.

In this case, an average surface roughness Ra of the inner circumferential surface of the shell 3F before the shrink-fitting step (step S104 illustrated in FIG. 7) is made larger than a tightening allowance in the shrink-fitting step. The term tightening allowance refers to a value obtained by subtracting the inner diameter of the shell 3F before fixing the stator core 10 therein from the outer diameter DS of the stator core 10 (FIG. 9).

With this configuration, even after the stator core 10 is fixed to the shell 3F by the shrink-fitting, the concave and convex portions on the inner circumferential surface of the shell 3F are not flattened. Thus, portions applied with no compressive stress by the shell 3F can be provided on the outer circumferential surface of the stator core 10, and thus the iron loss can be reduced.

In the sixth embodiment, by providing the grooves 38 or the concave and convex portions on the inner circumferential surface of the shell 3F, the portions applied with no compressive stress by the shell 3F can be distributed across the outer circumferential surface of the stator core 10. Thus, the stator core 10 can be fiLmly fixed to the shell 3F, and the iron loss in the stator core 10 can be reduced.

The grooves 38 or the concave and convex portions described in the sixth embodiment may be provided on the inner circumferential surface 32a of the second shell portion 32 described in the first, third, or fourth embodiment. Alternatively, as described in the fifth embodiment, the total area of the surface of the stator core 10 facing the shell 3F may be made larger than the total area of the surface of the stator core 10 contacting the shell 3F. Fitting portions between the stator core 10 and the shell 3F may be fixed by thermal crimping or arc spot welding.

### Modification

FIG. 22 is a cross-sectional view illustrating another configuration example of the stator core 10 of any one of the first to sixth embodiments together with the shell 3. The stator core 10 (FIG. 2) described in each of the above-described embodiments is famed of the plurality of split cores 8. A stator core 10A illustrated in FIG. 22 is famed of a plurality of connection cores 9 that are connected to each other at the outer circumferential portions of the yoke 11.

The connection core 9 is provided for each tooth 12. Split surface portions 91 are famed in the yoke 11. Each split surface portion 91 is a boundary between adjacent connection cores 9. The split surface portion 91 extends outward in the radial direction from the inner circumferential surface of the yoke 11, but does not reach the outer circumferential surface 11b of the yoke 11. A thin-walled portion 92 is famed between the outer end of the split surface portion 91 and the outer circumferential surface 11b of the yoke 11.

Thus, a strip-shaped body of the plurality of connection cores 9 arranged in a row can be rounded into an annular shape while defaming the thin-walled portions 92. Two of the connection cores 9 located at both ends of the strip-shaped body are bonded to each other at a welding portion W.

The stator core 10A is formed of the plurality of connection cores 9 connected via the thin-walled portions 92, and thus it is difficult to improve the roundness of the stator core 10A as compared to a stator core famed integrally in an annular shape. In each embodiment described above, the compressive stress from the shell 3 is concentrated on the second core portion 102 of the stator core 10, and thus the stator core 10 is tightened strongly. Thus, it is easy to improve the roundness.

The stator core is not limited to a configuration formed of the split cores 8 (FIG. 2) or the connection cores 9 (FIG. 22), but may be integrally famed in an annular shape.

### (Configuration of Compressor)

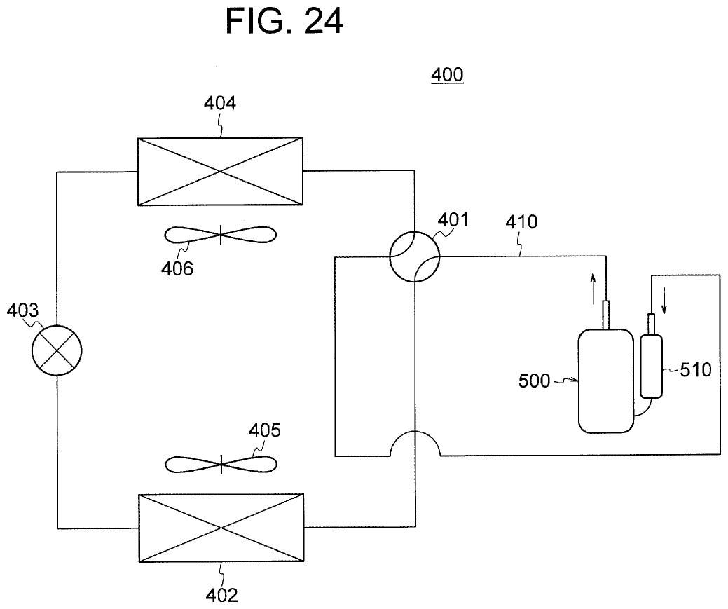

Next, a compressor 500 to which the motor of each embodiment is applicable will be described. FIG. 23 is a longitudinal-sectional view illustrating the compressor 500. The compressor 500 is a rotary compressor, and is used, for example, in an air conditioner 400 (FIG. 24). The compressor 500 includes a compression mechanism portion 501, the motor 100 that drives the compression mechanism portion 501, the shaft 56 that connects the compression mechanism portion 501 and the motor 100, and the sealed container 507 that accommodates these components. In this example, the axial direction of the shaft 56 is a vertical direction, and the motor 100 is disposed above the compression mechanism portion 501.

The sealed container 507 is a container made of a steel sheet and has the cylindrical shell 3, a container upper part that covers the upper side of the shell 3, and a container bottom part that covers the lower side of the shell 3. The stator 1 of the motor 100 is incorporated in the shell of the sealed container 507 by shrink-fitting, press-fitting, welding, or the like.

The container upper part of the sealed container 507 is provided with a discharge pipe 512 for discharging refrigerant to the outside and terminals 511 for supplying electric power to the motor 100. An accumulator 510 that stores refrigerant gas is attached to the outside of the sealed container 507. At the container bottom part of the sealed container 507, refrigerant oil is retained to lubricate bearings of the compression mechanism portion 501.

The compression mechanism portion 501 has a cylinder 502 with a cylinder chamber 503, a rolling piston 504 fixed to the shaft 56, a vane dividing the inside of the cylinder chamber 503 into a suction side and a compression side, and an upper frame 505 and a lower frame 506 which close both ends of the cylinder chamber 503 in the axial direction.

Both the upper frame 505 and the lower frame 506 have bearings that rotatably support the shaft 56. An upper discharge muffler 508 and a lower discharge muffler 509 are mounted onto the upper frame 505 and the lower frame 506, respectively.

The cylinder 502 is provided with the cylinder chamber 503 having a cylindrical shape about the axis C1. An eccentric shaft portion 56a of the shaft 56 is located inside the cylinder chamber 503. The eccentric shaft portion 56a has a center that is eccentric with respect to the axis C1. The rolling piston 504 is fitted to the outer circumference of the eccentric shaft portion 56a. When the motor 100 rotates, the eccentric shaft portion 56a and the rolling piston 504 rotate eccentrically within the cylinder chamber 503.

The cylinder 502 is provided with a suction port 515 through which the refrigerant gas is sucked into the cylinder chamber 503. A suction pipe 513 that communicates with the suction port 515 is attached to the sealed container 507. The refrigerant gas is supplied from the accumulator 510 to the cylinder chamber 503 via the suction pipe 513.

The compressor 500 is supplied with a mixture of low-pressure refrigerant gas and liquid refrigerant from a refrigerant circuit of the air conditioner 400 (FIG. 24). If the liquid refrigerant flows into and is compressed by the compression mechanism portion 501, this may cause the failure of the compression mechanism portion 501. Thus, the accumulator 510 separates the refrigerant into the liquid refrigerant and the refrigerant gas and supplies only the refrigerant gas to the compression mechanism portion 501.

For example, R410A, R4070, or R22 may be used as the refrigerant, but it is desirable to use a refrigerant with a low global warming potential (GWP) from the viewpoint of preventing global warming.

The operation of the compressor 500 is as follows. When current is supplied to the coils 15 of the stator 1 through the terminal 511, the rotating magnetic field generated by the current and the magnetic field of the permanent magnets 55 of the rotor 5 generate attractive or repulsive force between the stator 1 and the rotor 5, causing the rotor 5 to rotate. Accordingly, the shaft 56 fixed to the rotor 5 rotates.

The low-pressure refrigerant gas from the accumulator 510 is sucked into the cylinder chamber 503 of the compression mechanism portion 501 through the suction port 515. Within the cylinder chamber 503, the eccentric shaft portion 56a of the shaft 56 and the rolling piston 504 attached to the shaft portion 56a rotate eccentrically, thereby compressing the refrigerant in the cylinder chamber 503.

The refrigerant compressed in the cylinder chamber 503 is discharged into the sealed container 507 through a discharge port (not shown) and the discharge mufflers 508 and 509. The refrigerant discharged into the sealed container 507 flows upward inside the sealed container 507 through the holes 57 and 58 of the rotor core 50 and the like, and is then discharged through the discharge pipe 512. The discharged refrigerant is fed to a refrigerant circuit in the air conditioner 400 (FIG. 24).

The motors described in the first to sixth embodiments and the modifications are applicable to the compressor 500, and thus vibration and noise of the compressor 500 can be suppressed.

### (Air Conditioner)

Next, the air conditioner 400 including the compressor 500 illustrated in FIG. 23 will be described. FIG. 24 is a diagram illustrating the air conditioner 400. The air conditioner 400 includes the compressor 500 of the first embodiment, a four-way valve 401 as a switching valve, a condenser 402 to condense the refrigerant, a decompressor 403 to reduce the pressure of the refrigerant, an evaporator 404 to evaporate the refrigerant, and a refrigerant pipe 410 to connect these components.

The compressor 500, the four-way valve 401, the condenser 402, the decompressor 403, and the evaporator 404 are connected together by the refrigerant pipe 410 to configure a refrigerant circuit. The compressor 500 includes an outdoor fan 405 facing the condenser 402 and an indoor fan 406 facing the evaporator 404.

The operation of the air conditioner 400 is as follows. The compressor 500 compresses the sucked refrigerant, and discharges the compressed refrigerant as high-temperature and high-pressure refrigerant gas. The four-way valve 401 switches the flow direction of the refrigerant. During a cooling operation, the refrigerant discharged from the compressor 500 flows to the condenser 402 as illustrated in FIG. 24.

The condenser 402 exchanges heat between the refrigerant discharged from the compressor 500 and the outdoor air fed by the outdoor fan 405 to condense the refrigerant, and then discharges the condensed refrigerant as a liquid refrigerant. The decompressor 403 expands the liquid refrigerant discharged from the condenser 402, and then discharges the expanded refrigerant as a low-temperature and low-pressure liquid refrigerant.

The evaporator 404 exchanges heat between the indoor air and the low-temperature and low-pressure liquid refrigerant discharged from the decompressor 403 to thereby evaporate (vaporize) the refrigerant, and then discharges the evaporated refrigerant as refrigerant gas. Thus, air from which the heat is removed in the evaporator 404 is supplied by the indoor fan 406 to the interior of a room which is a space to be air-conditioned.

During a heating operation, the four-way valve 401 delivers the refrigerant discharged from the compressor 500 to the evaporator 404. In this case, the evaporator 404 functions as a condenser, while the condenser 402 functions as an evaporator.

Since vibration and noise of the compressor 500 can be suppressed as described above, the quietness of the air conditioner 400 can be enhanced.

Although the desirable embodiments of the present invention have been specifically described above, the present invention is not limited to the above-described embodiments, and various modifications or changes can be made to those embodiments without departing from the scope of the present invention.

1. A motor comprising:
a rotor rotatable about an axis;
a stator having a stator core surrounding the rotor from an outer side in a radial direction about the axis; and
an annular shell in which the stator core is fixed,
wherein the shell comprises:
a first shell portion facing the stator core in the radial direction and having an inner diameter D1;
a second shell portion contacting the stator core in the radial direction and having an inner diameter D2; and
a third shell portion provided on each of both sides of the stator core in a direction of the axis and having an inner diameter D3, and
wherein the inner diameters D1, D2 and D3 satisfy D1>D2 and D1>D3.

2. The motor according to claim 1, wherein the inner diameters D2 and D3 satisfy D2≥D3.

3. The motor according to claim 1, wherein the first shell portion has a concave portion on a side thereof facing the stator core.

4. The motor according to claim 1, wherein the stator core is fixed to the shell by a crimping portion or a welding portion.

5. The motor according to claim 1, wherein the stator core is formed of a plurality of core elements connected in a circumferential direction about the axis.

6. The motor according to claim 1, wherein the first shell portion is formed at a position corresponding to a central portion of the stator core in the direction of the axis.

7. The motor according to claim 1, wherein the second shell portion is formed at a position corresponding to an end portion of the stator core in the direction of the axis.

8. The motor according to claim 1, wherein the second shell portion is formed at a position corresponding to a central portion of the stator core in the direction of the axis.

9. The motor according to claim 1, wherein the first shell portion is formed at a position corresponding to an end portion of the stator core in the direction of the axis.

10. The motor according to claim 1, wherein the third shell portion is adjacent to the first shell portion or the second shell portion in the direction of the axis.

11. The motor according to claim 1, wherein an area of a surface of the first shell portion facing the stator core is larger than an area of a surface of the second shell portion contacting the stator core.

12. The motor according to claim 1, wherein a length of the first shell portion in the direction of the axis is longer than a length of the second shell portion in the direction of the axis.

13. The motor according to claim 1, wherein a groove is formed on a surface of the first shell portion facing the stator core.

14. A compressor comprising the motor according to claim 1 and a compression mechanism driven by the motor.

15. An air conditioner comprising the compressor according to claim 14, a condenser, a decompressor, and an evaporator.

16. A manufacturing method of a motor, the manufacturing method comprising the steps of:
preparing a shell having an annular shape about an axis and comprising a first shell portion having an inner diameter D1, and a second shell portion having an inner diameter D2 smaller than the inner diameter D1, the shell further having a third shell portion on each of both sides thereof in a direction of the axis, the third shell portion having an inner diameter D3 smaller than the inner diameter D1;
fixing a stator core in the shell in such a manner that the first shell portion faces the stator core in a radial direction about the axis, the second shell portion contacts the stator core in the radial direction, and the third shell portion is located on each of both sides of the stator core in a direction of the axis; and
mounting a rotor on an inner side of the stator core.

17. The manufacturing method of a motor according to claim 16, wherein in the step of fixing the stator core in the shell, the stator core is fixed in the shell by shrink-fitting or press-fitting.

18. The manufacturing method of a motor according to claim 17, wherein an average surface roughness of an inner circumferential surface of the shell before the shrink-fitting is larger than a tightening allowance for the shrink-fitting.

19. The manufacturing method of a motor according to claim 16, wherein in the step of fixing a stator in the shell, the stator core and the shell are fixed to each other by thermal crimping or welding.
